(19) United States
(12) Patent Application Publication
(10) Pub. No.: US 2005/0163936 A1
(43) Pub. Date: Jul. 28, 2005

(54) Method for coloring various rock types

(76) Inventors: Rick Lewis Beatty, Hurricane, UT (US); Hans William Rasmussen, Mesquite, NV (US)

Correspondence Address: RICK LEWIS BEATTY, 554 SOUTH 180 WEST, HURRICANE, UT, 84737, US

(21) Appl. No.: 11/044,530

(22) Filed: Jan. 26, 2005

Related U.S. Application Data
(60) Provisional application No. 60/539,524, filed on Jan. 26, 2004.

(51) Int. Cl. C05F 11/02

(52) U.S. Cl. 427/444

(57) ABSTRACT

A novel method for coloring various rock types to duplicate the natural color so-called, Desert Varnish. By using mixtures of the Humic acid or Fulvic acid in conjunction with buffered metal hydroxide and metal salt solutions, the colors of natural color can be exactly duplicated. The natural absorption and chelating power for the transition metal and other metal ions by the Humic acid or Fulvic acid when used in conjunction with low concentrations of the salts of the transition metals allow for the naturally chelated metal complexes and salts to absorb into the rock surface to impart the desired color. The Humic acid or Fulvic acid is derived from humic substances such as leonardite clay. The clay serves as an insoluble fraction that settles in the vugs and recesses of the rock, imparting random patterns of darker colors, much like natural desert varnish.

### CROSS-REFERENCE TO RELATED APPLICATIONS

This application claims the benefit of provisional patent application Ser. No. 60/539,524, filed Jan. 26, 2004 by the present inventor.

### FEDERALLY SPONSORED RESEARCH

Not applicable

### SEQUENCE LISTING OR PROGRAM

Not applicable

### BACKGROUND OF THE INVENTION

1. Field of Invention

This invention relates to the use of the natural absorption and chelating ability of the Humic acid or Fulvic acid to chelate transition metal salts of the Group 6 through 8 transition metal series and other metal salts, for permanent staining of any naturally occurring rock minerals, or industrial forms made therefrom, such as brick, cinder blocks, concrete blocks, concrete retaining walls, aerated concrete, and a host of other uses, shapes and varieties.

2. Prior Art

Prior art includes the use of pigments, stains, various inorganic chemical additives and chlorides. Commonly used blends for imparting stain to new rock surfaces are metal Chlorides and metal Acetate mixtures made from Iron, Manganese, and Chrome salts, coupled with natural pigments of the above mentioned salts; all of the above admixtures of metal ion salts are in an attempt to duplicate the natural stains on rock minerals called Desert Varnish. Desert Varnish is a smooth coating that accumulates on rock formations ranging from small boulders to cliffs hundreds of feet high. It is a natural process causing a glossy, or semi-glossy darkened varnished finish through interaction with water and minerals from the soil.

Prior art inventors use higher concentrations of metallic salts in aqueous solution. The metal salt solutions are generally used in the Chloride or Acetate form of the metals. These type of solutions can damage groundwater and water aquifers. This is due to the effect that chloride and acetate ions have much higher soil mobility than either Humic acid or Fulvic acid. Our invention to simulate desert varnish is specifically developed to reduce the molar concentration requirements for the Manganese and Iron salts used by prior art methods. Prior art methods use Acetic Acid or Hydrochloric Acid components; whereas, we use in our invention Humic acid or Fulvic acid in order to reduce potential damage to groundwater and water aquifers.

Humic acid or Fulvic acid are environmentally safe organic acids that result from the natural decomposition of vegetation and are commonly found around the world being present in the forest, as well as composted products used in farming and gardening. The high cation exchange capacity of Humic acid or Fulvic acid is responsible for the transport of the transition metals so necessary for plant growth and has previously been shown to demonstrate excellent absorption and chelation characteristics with transition metals for pollution control and pollution management applications.

Our invention has a very low molar concentration use of Humic acid or Fulvic acid which allows for low levels of metal salts to be used for the permanent coloring effects in simulated desert varnish because of the unique absorption properties of the Humic acid or Fulvic acid.

Another type method of forming a decorative novelty device using stone material which comprises of treating the stone surface with a wash medium, applying one or more thin coatings of clear polyurethane, apply a decorative element, allowing the application of one or more thin coatings, thus causing the stone to have a shiny surface. This prior art lacks the ability to simulate the natural desert varnish. Our invention causes a natural desert varnish appearance in one simple application.

Another type method of simulating natural desert varnish using Sodium Hydroxide and Potassium Hydroxide, Manganese Chloride, and Iron Sulfate and Sodium Hypochloride in amounts that are not as friendly to the environment. Our invention using naturally occurring ecologically safe Humic acid or Fulvic acid makes the present invention method more friendly to the natural environment and increases the permeability of plant membranes, promoting the uptake of nutrients. Humic acid can be especially beneficial in dry areas by aiding in water retention for plant root systems.

Another type method for coating rock or the like to simulate natural desert varnish by using metallic acetate salts which consist of Ammonium and Sodium Acetate in high molar concentrates which is not as friendly to the natural environment as Humic acid or Fulvic acid based solutions from which our invention is composed. The use of naturally occurring environmentally friendly Humic acid or Fulvic acid has a great advantage over this prior art method for simulating a natural desert varnish.

Another type method for staining concrete comprising saturated Hydrochloric Acid solutions of blended metallic salts that are chemically reactive with masonry concrete, stone, and like materials. This prior art having Hydrochloric Acid solutions are harmful to the environment. Our invention uses Humic acid or Fulvic acid solutions that are environmentally safe organic acids.

The above stated prior art methods and products are used to produce a desert varnish that rely on the use of soluble Iron Acetate and Manganese Acetate salts, Chloride, Ammonia, or Sulfate salts to stain or impart color by topical application to rock minerals and soil. Iron salts are introduced as the Nitrate, Chloride, Ammonium or Sulfate forms, and are mixed with Ammonium, Potassium, or Sodium Acetate to form the soluble Iron salts necessary for application. This technique can be used using other metal salts to provide alternate shades of color. The Nitrate, Chloride, Sulfate, Ammonium, Potassium and Sodium Ionic Salts that are used in making the Iron Acetate do not go away and will remain with the Iron Acetate solution as soluble salts, which can then pass into the immediate surrounding environment given time and exposure to natural weather effects. These salts when dissolved in water can effect the ground water or corresponding aquifers.

Corresponding situations would occur with Ferric, Manganous or other transition metal compounds, mixed with Sodium Acetate and dissolved in water to make the topical spray. The Iron Acetate would remain as a water soluble compound and would have the same limited absorption into the rock matrix before drying, yielding the color. This is how the “staining” or “Desert Varnish” color effects are derived.

The prior art method that relies on first spraying the area with Sodium Hydroxide solution, followed by a spray of Ferric or Ferrous Chloride, which would react with the Sodium Hydroxides. Unfortunately, these Hydroxides and Chloride ions are largely soluble and could eventually contaminate surrounding waters and aquifers.

The base material we use in our present invention is 100% natural and acts as the primary carrier of the coloring agents. It will not allow for free ion transfer to the surrounding waters or aquifers. We also derived a material that is used at a neutral pH and would not adversely affect the mineral strata that it is applied to. This statement cannot be made with the prior art products and methods being applied.

### OBJECTS AND ADVANTAGES

Accordingly, besides the objects and advantages described above, several objects and advantages of the present invention are:
(a) to provide a method for coloring various rock types that is safer to the environment.
(b) to provide a method that is less expensive to produce and to apply.
(c) to provide naturally occurring environmentally friendly Humic acid or Fulvic acid as a host to impart and assist in the transport of the chelated metal salts into the rock mineral surface.
(d) to provide a method that does not use the metal salt solution using chloride or acetate.
(e) to provide a method using Humic acid or Fulvic acid that are safe organic acids.
(f) to provide a method having excellent absorption and chelation characteristics with transition metals for pollution control and pollution management applications.
(g) to provide a method using very low concentration use of Humic acid or Fulvic acid.
(h) to provide a method that eliminates the use of Acetic acid or Hydrochloric acid components or their salts.
(i) to provide a method that allows for amendment acids which are beneficial to surrounding plants and plant root systems.

It is the feature of the present invention to provide a method for coloring various rock types comprising the use of Humic acid or Fulvic acid which are environmentally safe organic acids that result from the natural decomposition of vegetation and commonly found around the world being present in the forest and, also, composted products used in farming and gardening. The high cation exchange capacity of Humic acid or Fulvic acid is responsible for the transport of the transition metals so necessary for plant growth and has excellent absorption and chelation characteristics with transition metals for pollution control and pollution management applications. The use of Humic acid or Fulvic acid allows for low molar levels of metal salts to be used for the permanent staining effects in simulated desert varnish because of the unique absorption properties of Humic acid or Fulvic acid. The present invention reduces the concentration requirements for the Manganese and Iron salts used by other methods. The Humic acid and Fulvic acid eliminates the use of Acetic Acid or Hydrochloric Acid components or their salts reducing potential damage to groundwater or water aquifers.

Other objects and features are readily apparent from the following embodiments thereof taken in conjunction with the accompanying photos although variation and modifications may be affected with departing from the sphere and the scope of the normal concepts of the disclosed invention. You will find further objects and advantages of the invention from a consideration of the ensuring descriptions and accompanying photos.

### PHOTO FIGURES

FIG. 1 Shows a rock the left front surface treated with a Humic acid with iron solution and the right front surface treated with a Humic acid with Manganese solution simulating a natural Desert Varnish finish.

FIG. 2 Shows a rock the left front surface treated with a Humic acid with iron and Manganese solution simulating a natural Desert Varnish finish.

FIG. 3 Shows a rock front surface treated with a Humic acid and Fulvic acid combination solution simulating a natural Desert Varnish finish.

### DESCRIPTION OF INVENTION

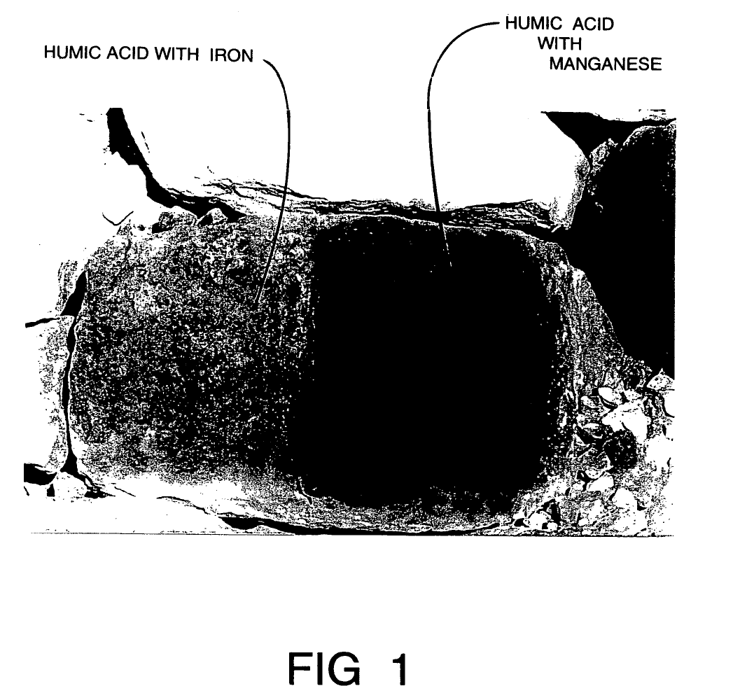

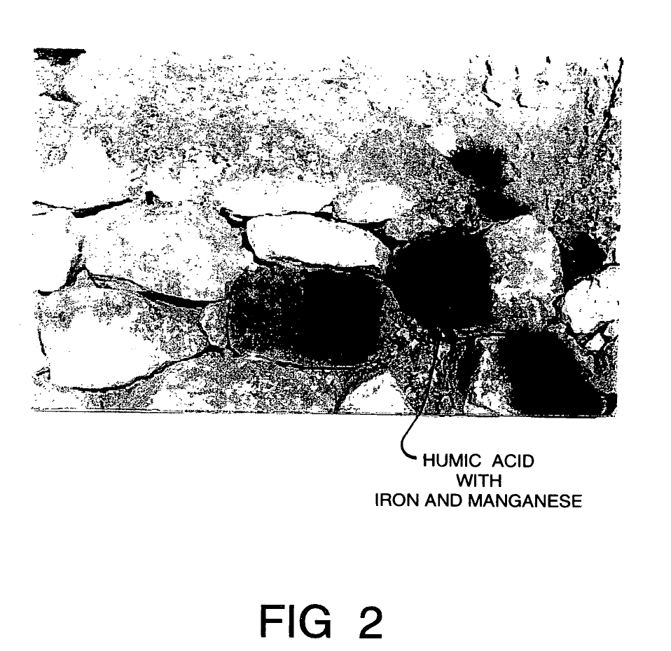

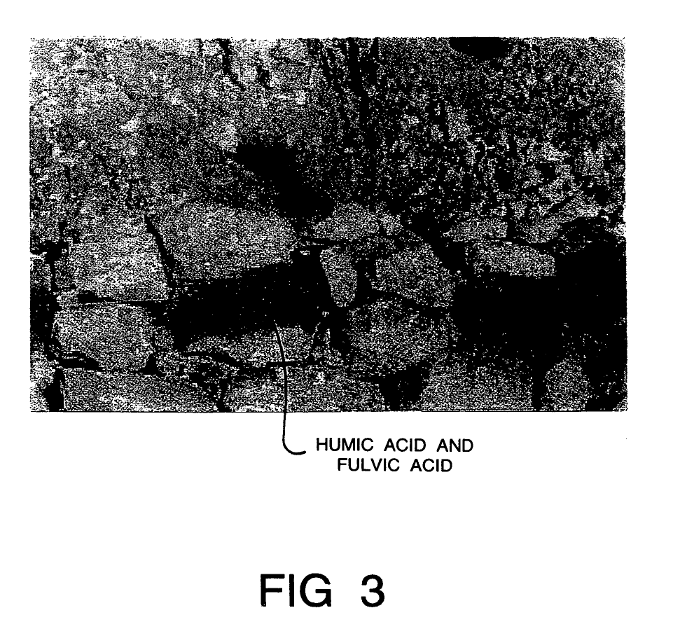

Method for coloring various rock types shown in FIG. 1, FIG. 2, and FIG. 3 comprises of a method to duplicate the natural process so-called Desert Varnish. By using mixtures of the Humic acid or Fulvic acid in conjunction with buffered metal hydroxide and metal salt solutions, the colors of natural Desert Varnish can be exactly duplicated. Advantage is taken of the natural absorption and chelating power for transition metal ions by the Humic acid or Fulvic acid which allows for the naturally chelated metal complexes and salts to absorb into the rock surface to impart the desired color. The high concentration of transition metals or metal salts required by prior art is environmentally less desirable and not required by this present invention. The Humic acid or Fulvic acid is primarily derived from but not limited to leonardite clay. The clay serves as an insoluble fraction that settles in the vugs and recesses of the rock, imparting random patterns of darker colors, much like natural Desert Varnish. Humic acid or Fulvic acid are environmentally safe organic acids resulting from the natural decomposition of vegetation, and are commonly present in the composted products used as fertilized additives in farming and gardening.

### CONCLUSION AND SCOPE OF INVENTION

Accordingly, the reader will see that the “Method for Coloring Various Rock Types” of this invention has the ability to simulate the natural desert varnish by using the naturally occurring environmentally friendly Humic acid or Fulvic acid as a host to impart and assist in the transport of the chelated metal salts into the rock mineral surface. Also, the present invention to improve the environmental impact and cost effectiveness of the deficiencies in the prior art by reducing the quantities of metal salts required for acceptable staining of the earth minerals. Furthermore, the method for coloring various rock types has the additional advantages in that:
it provides an environmentally safe method to simulate the Desert Varnish on various rock types.
it permits individual application that is less costly to produce.
it allows the method to be applied near water supplies with no damage to the water.
it provides for an application of a lower concentration of transition metals or metal salts.
it provides excellent characteristics for the absorption and chelation with the transition metals for pollution control.
it provides a safer environment for the individual applying the method.
it provides a one-step method for simulating a natural Desert Varnish.

Although the description above contains many specifications, these should not be construed as limiting the scope of the invention but merely providing illustrations of some of the presently preferred embodiments of this invention. For example, the method of this invention may be a combination of Humic acid or Fulvic acid with a combination of Iron, Manganese and other chelated metal complexes or any combination of these materials with the intention of this present invention to have it environmentally friendly in its production and application.

1. Method for coloring various rock types which comprises: Humic acid or Fulvic acid in conjunction with transition metal salts and other metal salts, as a method for coloring natural rock or man made material surfaces to develop a natural color commonly referred to as Desert Varnish. Said Humic acid or said Fulvic acid a more environmentally safe application of their absorption and chelating agents.

2. Method for coloring various rock types according to claim 1 wherein said Humic acid or said Fulvic acid are extracted from Leonardite clay.

3. Method for coloring various rock types according to claim 1 wherein said Humic acid or said Fulvic acid may be peat, compost or any other source of humas material derived from anaerobic decomposition of organic materials.

4. Method for coloring various rock types according to claim 1 wherein said Humic acid or said Fulvic acid is combined with various quantities of water.

5. Method for coloring various rock types according to claim 4 wherein the aqueous suspension has a pH which is about the isoelectric point of said Humic acid or said Fulvic acid.

6. Method for coloring various rock types according to claim 5 wherein said aqueous suspension is screened through a 100 mesh (150 micron) screen to separate insoluble waste fraction from said Humic acid or said Fulvic acid solution.

7. Method for coloring various rock types according to claim 1 wherein said Humic acid or said Fulvic acid become a buffered solution by the use of sodium hydroxide in the presence of Humic material.

8. Method for coloring various rock types according to claim 7 wherein said Humic acid or said Fulvic acid solution is mixed in varying amounts with different acids or near neutral solutions of said transition metal salts or other transition metal salts, when applied to natural rock minerals, producing said natural color closely duplicating said Desert Varnish.

9. Method for coloring various rock types according to claim 1 wherein substantially reduced amounts of said transition metal salts to be used to achieve the desired said natural color.

10. Method for coloring various rock types according to claim 1 wherein said Humic acid is used singularly in conjunction with said transition metal salts.

11. Method for coloring various rock types according to claim 1 wherein said Fulvic acid is used singularly in conjunction with said transition metal salts.

12. Method for coloring various rock types according to claim 1 wherein said Desert Varnish is produced as a one-step application.
